(19) United States
(12) Patent Application Publication
(10) Pub. No.: US 2025/0371601 A1
(43) Pub. Date: Dec. 4, 2025

(54) TECHNIQUES FOR PERSONALIZED RECOMMENDATION USING USER FOUNDATION MODELS

(71) Applicant: NETFLIX, INC., Los Gatos, CA (US)

(72) Inventors: Moumita BHATTACHARYA, San Jose, CA (US); Sudarshan Dnyaneshwar LAMKHEDE, Sunnyvale, CA (US); Vito Claudio OSTUNI, Belmont, CA (US)

(21) Appl. No.: 19/022,469

(22) Filed: Jan. 15, 2025

Related U.S. Application Data
(60) Provisional application No. 63/655,524, filed on Jun. 3, 2024.

(51) Int. Cl. G06Q 30/0601; G06N 20/00

(52) U.S. Cl. CPC G06Q 30/0631; G06N 20/00

(57) ABSTRACT

Techniques for generating recommendations using a recommendation model include receiving one or more user inputs, determining one or more context features based on one or more context inputs, determining one or more user features based on the one or more user inputs, determining one or more user embeddings based on the one or more user features, determining one or more context embeddings based on the one or more context features, merging the one or more user embeddings and the one or more context embeddings to generate one or more merged embeddings; and generating recommendations based on the one or more merged embeddings.

### CROSS-REFERENCE TO RELATED APPLICATIONS

This application claims priority benefit of the United States Provisional Patent Application titled, “JOINT MODELING OF SEARCH AND RECOMMENDATIONS VIA A UNIFIED CONTEXTUAL RECOMMENDER,” filed on Jun. 3, 2024, and having Ser. No. 63/655,524. The subject matter of this related application is hereby incorporated herein by reference.

### BACKGROUND

### Technical Field

The embodiments of the present disclosure relate generally to computer science and machine learning, and more specifically, to techniques for personalized recommendation using user foundation models.

### Description of the Related Art

Recommendation systems are widely used across digital platforms to enhance user experience by providing personalized recommendations based on user interactions and preferences. Recommendation systems are used in applications, such as video streaming services, online shopping, social media, and/or the like, where recommendation systems assist users in discovering content, products, or services that are relevant to the users' interests. For example, a video streaming platform, such as Netflix, includes recommendation systems that analyze viewing habits, such as the genres, directors, or actors a user frequently watches, to recommend movies, TV shows, or documentaries that the user is likely to enjoy. Online shopping, platforms, such as Amazon, eBay, and/or the like, include recommendation systems that analyze past purchases, browsing history, and wish lists to recommend products that could interest the user, such as related electronics, clothing, or household items. Social media platforms, such as Facebook, Instagram, and/or the like, include recommendation systems that curate content feeds, recommending posts, friends, groups, or advertisements based on a user's interactions, such as likes, shares, and comments.

One conventional approach used in recommendation systems is content-based filtering, which includes training machine learning models that recommend items similar to the items a user has interacted with or liked in the past. For example, in a video streaming platform, a user who has watched several science fiction movies could receive recommendations for other science fiction films or TV shows. Similar to a video streaming platform, in an online shopping platform, a user who has purchased several fitness-related products could receive recommendations for other fitness gear or health supplements. Content-based filtering is based on the attributes of the items, such as genre, actors, directors in the case of video content, or product category, brand, and features in the case of physical goods, and the user's historical interactions with the attributes. Another conventional approach in recommendation systems is collaborative filtering, which includes training machine learning models which recommend items that are popular among users with similar preferences. For example, in a video streaming platform, a feature like “viewers who watched this also watched” is based on collaborative filtering, where the recommendation system recommends movies or TV shows based on the viewing patterns of other users with similar interests. Similar to a video streaming platform, in an e-commerce platform, a recommendation like “customers who bought this also bought” is derived from collaborative filtering, where the recommendation system recommends products based on the purchasing behavior of users with similar shopping habits. On social media platforms, features like “people you may know” are also based on collaborative filtering, where potential connections are suggested based on the interaction patterns of users with overlapping social circles.

One drawback of conventional recommendation systems is that conventional recommendation systems often deploy separate models for different tasks. For example, in a video streaming platform, one model can be dedicated to generating search results based on a user's query, while another model is used to recommend personalized content based on the user's viewing history. A third model can be used to provide contextual recommendations, such as recommending related content after a user finishes watching a particular movie or series. Each of the models requires a specific data pipeline, processing framework, and set of algorithms tailored to a specific task. The management and maintenance of multiple models can lead to increased complexity within the recommendation system. The complexity manifests in several ways, such as the need for separate data storage and retrieval systems for each model, increased computational resources to train and deploy multiple models, and the potential for inconsistent user experiences due to the varying performance of different models. Managing the distinct models can become resource-intensive, requiring constant monitoring, updates, and tuning to ensure each model performs. Additionally, the need to synchronize outputs from different models can lead to delays in delivering recommendations, which can negatively impact user experience. Another drawback of conventional recommendation systems is that the model for one task can often influence or interfere with the model for another task. For example, in a video streaming platform, a search model trained for recommending relevant results to a user query can conflict with a personalized recommendation model designed to recommend content based on user preferences. For example, a user searching for a specific movie can receive search results influenced by the user's viewing history or past preferences, rather than query-relevant results. The overlap between models can create inconsistencies and lead to suboptimal recommendations, requiring additional effort to manage and harmonize the outputs from each model.

As the foregoing illustrates, what is needed in the art are more effective techniques for recommendation systems.

In sum, techniques are disclosed to generate personalized recommendations using user foundation models. The disclosed techniques include a recommendation model, which is a machine learning model that processes user features and context features and generates recommendations. The recommendation model includes a user foundation model that processes user features and generates user embeddings, as well as a context model that processes context features and generates context embeddings. To train the recommendation model, first the user foundation model is trained using user interaction data. Once the foundation model is trained, the recommendation model, including the context model, is trained based on features extracted from contextual task-specific data and tasks, while the parameters of the trained foundation model are kept frozen. Subsequent to the training, the trained recommendation model can be used to generate personalized recommendations based on user inputs and context inputs. When context inputs are not available, the disclosed techniques impute the context inputs based on various heuristics. The disclosed techniques also include caching the user embeddings to reduce latency, retrieving user embeddings from a cache if the user foundation model has already processed the corresponding user features.

### SUMMARY

One embodiment of the present disclosure sets forth a computer-implemented method for receiving one or more user inputs, determining one or more context features based on one or more context inputs, determining one or more user features based on the one or more user inputs, determining one or more user embeddings based on the one or more user features, determining one or more context embeddings based on the one or more context features, merging the one or more user embeddings and the one or more context embeddings to generate one or more merged embeddings; and generating recommendations based on the one or more merged embeddings.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that the disclosed techniques include a single recommendation model that processes both user features and context features, which eliminate the need for separate models for different tasks. By integrating various tasks into a single recommendation model, the disclosed techniques reduce the computational overhead associated with maintaining distinct data pipelines for distinct task-specific models. Another technical advantage of the disclosed techniques is that, by unifying the generation of user embeddings and context embeddings within a single recommendation model, the potential for conflicting outputs between models is reduced. In addition, the disclosed techniques include caching mechanisms to reduce latency in generating recommendations. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a block diagram of a content server that can be implemented in conjunction with the network infrastructure of FIG. 1, according to various embodiments;

FIG. 3 is a block diagram of a control server that can be implemented in conjunction with the network infrastructure of FIG. 1, according to various embodiments;

FIG. 4 is a block diagram of an endpoint device that can be implemented in conjunction with the network infrastructure of FIG. 1, according to various embodiments;

FIG. 5 is a block diagram of a computer-based system according to various embodiments;

FIG. 6A is a more detailed illustration of the user foundation model trainer of FIG. 5, according to various embodiments;

FIG. 6B is a more detailed illustration of the recommendation model trainer of FIG. 5, according to various embodiments;

FIG. 7 is a more detailed illustration of the recommendation application of FIG. 5, according to various embodiments;

FIG. 8 sets forth a flow diagram of method steps for training the recommendation model of FIG. 5, according to various embodiments;

FIG. 9 sets forth a flow diagram of method steps for training the context model of FIG. 5, according to various embodiments;

FIG. 10 sets forth a flow diagram of method steps for generating recommendations, according to various embodiments; and

FIG. 11 sets forth a flow diagram of method steps for processing user features and generating user embeddings, according to various embodiments.

### DETAILED DESCRIPTION

In the following description, numerous specific details are set forth to provide a more thorough understanding of the embodiments of the present invention. However, it will be apparent to one skilled in the art that the embodiments of the present invention may be practiced without one or more of these specific details.

### System Overview

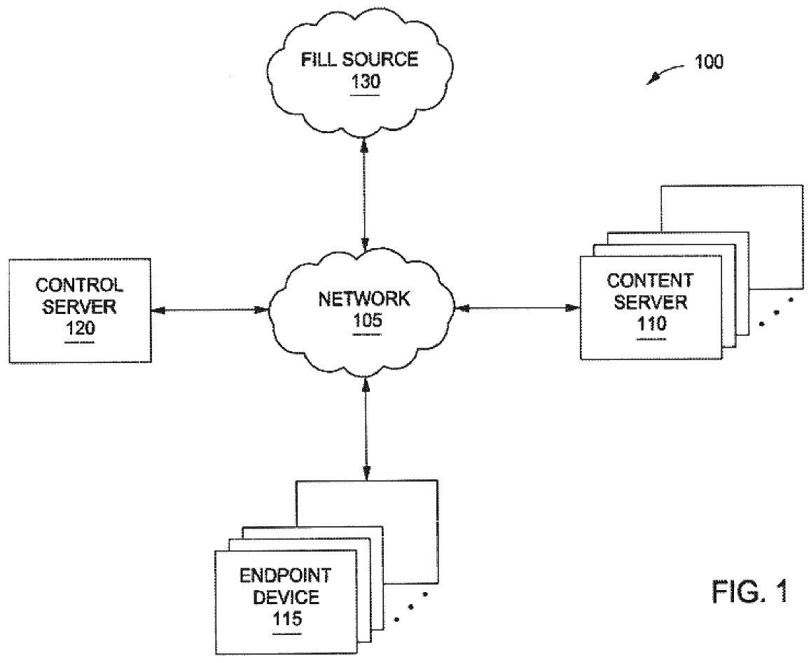

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

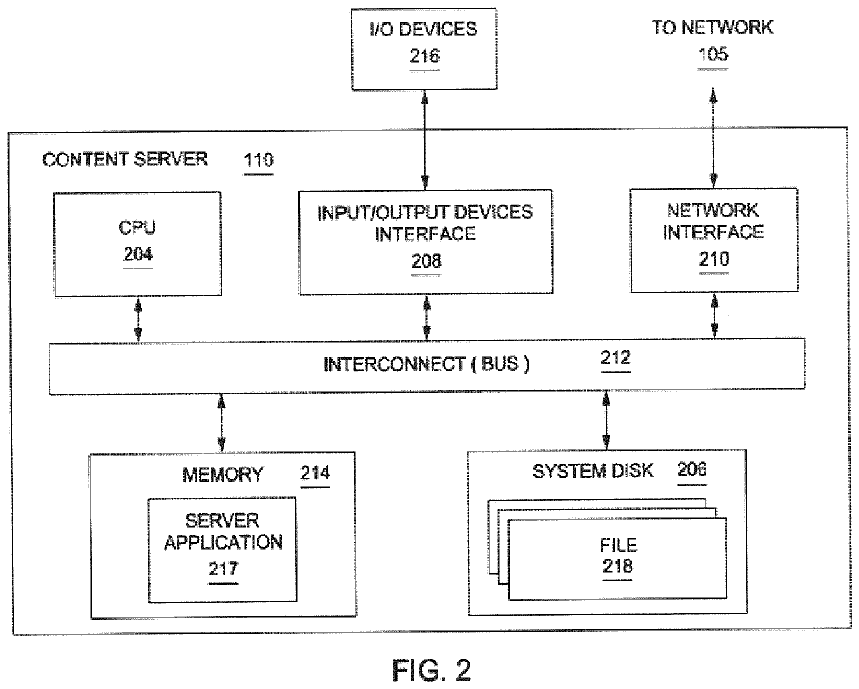

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

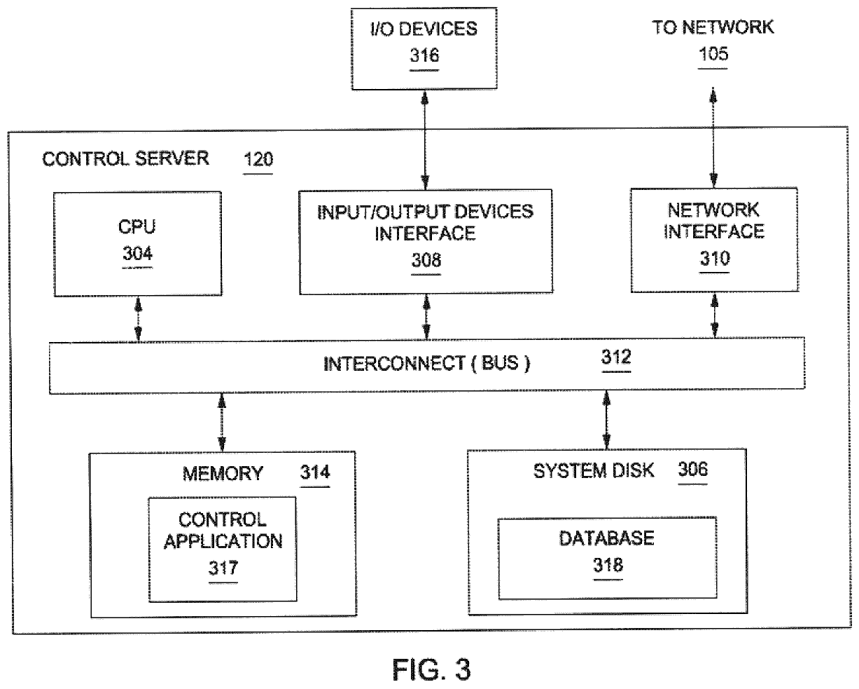

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

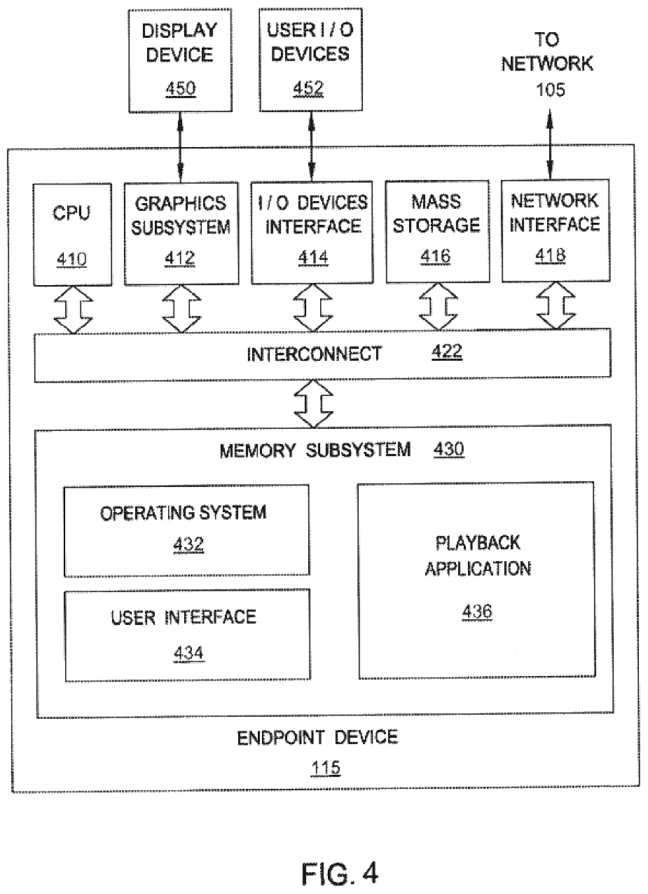

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 110 via the network interface 418. Further, the playback application 436 is configured to interpret the content and present the content via display device 450 and/or user I/O devices 452.

### Personalized Recommendation Using User Foundation Models

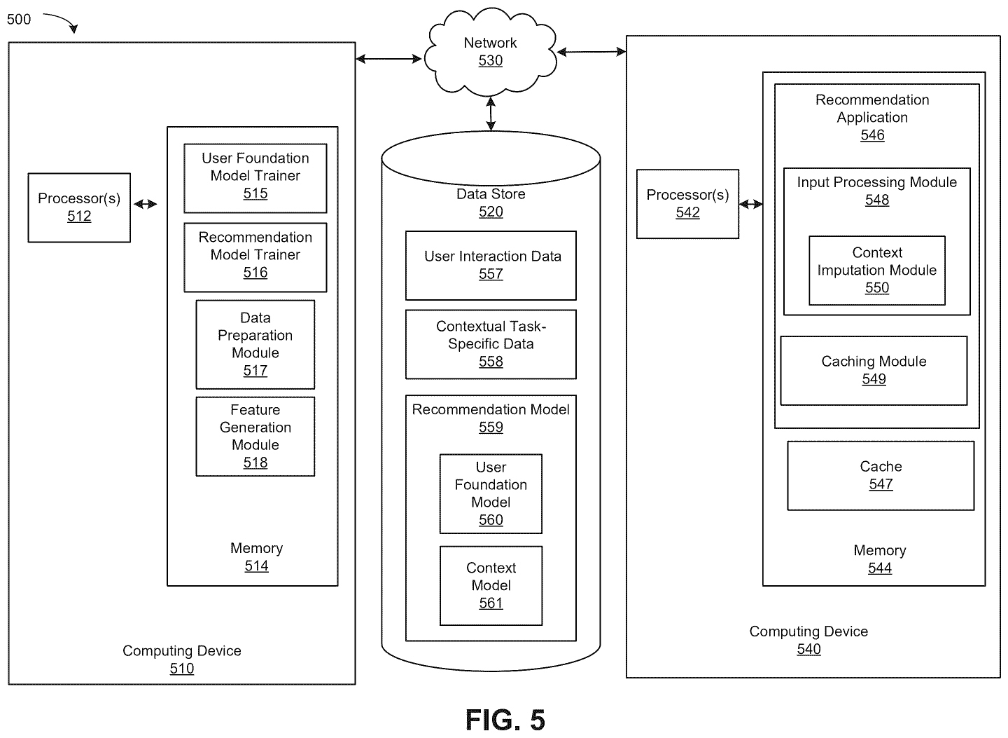

FIG. 5 is a block diagram of a computer-based system 500 according to various embodiments. As shown, the computer-based system 500 includes, without limitation, computing devices 510 and 540, a data store 520, and a network 530. Computing device 510 includes, without limitation, one or more processors 512 and memory 514. Memory 514 includes, without limitation, a user foundation model trainer 515, a recommendation model trainer 516, a data preparation module 517, and a feature generation module 518. Data store 520 includes, without limitation, user interaction data 557, contextual task-specific data 558, and a recommendation model 559. Recommendation model 559 includes, without limitation, a user foundation model 560 and a context model 561. Computing device 540 includes, without limitation, one or more processors 542 and memory 544. Memory 544 includes, without limitation, a recommendation application 546 and a cache 547. Recommendation application 546 includes, without limitation, an input processing module 548 and a caching module 549. Input processing module 548 includes, without limitation, a context imputation module 550. Although FIG. 5 is described in the context of recommendation systems, it is understood that the disclosed techniques are also applicable to other areas of personalization and data-driven systems, such as targeted advertising platforms, product recommendation engines, dynamic user interface customization, personalized educational content delivery, and/or the like.

Computing device 510 shown herein is for illustrative purposes only, and variations and modifications in the design and arrangement of computing device 510, without departing from the scope of the present disclosure. For example, the number of processors 512, the number of and/or type of memories 514, and/or the number of applications and or data stored in memory 514 can be modified as desired. In some embodiments, any combination of processor(s) 512 and/or memory 514 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications.

Memory 514 of computing device 510 stores content, such as software applications and data, for use by processor(s) 512. As shown, memory 514 includes, without limitation, a user foundation model trainer 515, a recommendation model trainer 516, a data preparation module 517, and a feature generation module 518. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

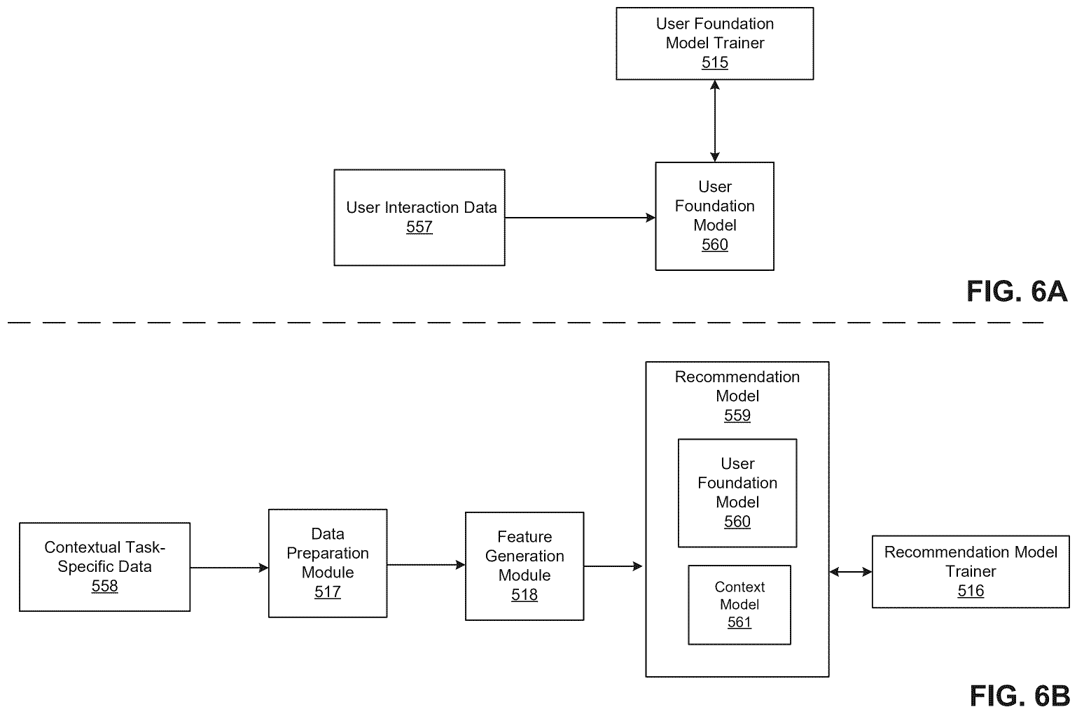

User foundation model trainer 515 trains user foundation model 560 using user interaction data 557. User interaction data 557 includes broad patterns of user behavior and activity across various recommendation tasks, providing insights into what the user engages with, how the user interacts, and the preferences of the user over time. For example, in a video streaming platform, user interaction data 557 can include viewing history, watch time for specific genres, interactions such as pausing or skipping content, and search queries. Additionally, user interaction data 557 includes implicit feedback, such as content that users hover over, actions such as fast-forwarding through content, and/or the like. User interaction data 557 also includes user-content interactions across various tasks, such as query-content recommendation, where the data includes the user's search queries and the corresponding content engagement, content-content recommendation, where interactions between different pieces of content are tracked (e.g., watching related movies or shows), and pre-query tasks, where engagement patterns prior to a search or content request are recorded. In an e-commerce platform, user interaction data 557 can include product views, items added to carts, purchase history, and even browsing behavior, such as time spent on product pages, the frequency of returning to certain categories, and/or the like. In a social media platform, user interaction data 557 can include likes, shares, comments, and profile visits. In some examples, user interaction data 557 is developed by capturing user engagements on Netflix products, with negative samples randomly selected from the product catalog that the user has not interacted with or selected. The negative samples represent content that the user did not engage with, helping user foundation model 560 to distinguish between content the user is likely to prefer and content the user is less interested in during training. The dataset is split into training, validation, and test sets, with the test set kept independent of the training and validation data to ensure unbiased evaluation. In at least one embodiment, the training process of user foundation model 560 includes the use of supervised or unsupervised learning techniques, where user foundation model 560 is optimized using techniques, such as the Adaptive Moment Estimation (Adam) optimizer, stochastic gradient descent (SGD), Root Mean Square Propagation (RMSProp), and/or the like, to minimize a loss function, such as cross entropy loss and/or the like, and improve user embedding generation performance of user foundation model 560. In some embodiments, foundation model trainer 515 uses regularization techniques, such as dropout, L2 regularization (Ridge regression), batch normalization, and/or the like, to prevent overfitting and improve the generalization of user foundation model 560. In some examples, user foundation model 560 can be pre-trained on large-scale engagement data and fine-tuned using task-specific data. In some embodiments, user foundation model trainer 515 trains user foundation model 560 in iterative training cycles, employing cross-validation, early stopping, and/or the like, to avoiding overfitting. User foundation model trainer 515 is described in more detail in conjunction with FIG. 6A.

Recommendation model trainer 516 trains recommendation model 559 using contextual task-specific data 558. In various embodiments, recommendation model trainer 516 freezes the trained user foundation model 560 and trains the remaining components of recommendation model 559, including but not limited to context model 561, to handle task-specific recommendations. Contextual task-specific data 558 includes data related to various recommendation tasks, such as query-content recommendation, content-content recommendation, pre-query tasks, and/or the like. For example, in a query-content recommendation task, contextual task-specific data 558 could include the user's specific search queries, the results returned in terms of entity identifier, and the corresponding user engagement with the returned content. In content-content recommendation tasks, contextual task-specific data 558 could include interactions between related content items (e.g., watching a movie and then engaging with the movie sequels or related genres). In pre-query tasks, contextual task-specific data 558 could capture user behaviors prior to initiating a search, such as browsing activity or hovering over content items without directly engaging. Contextual task-specific data 558 also includes other contextual details, such as the type of query (e.g., keyword search or voice command), the Ul page from which the query originates (e.g., homepage or genre-specific page), and/or the like. In some embodiments, recommendation model trainer 516 uses SGD technique to minimize task-specific loss functions, such as cross entropy loss and/or the like. In various embodiments, recommendation model trainer 516 evaluates recommendation model 559 during training using various ranking metrics, such as Normalized Mean Reciprocal Rank (NMRR) and Normalized Discounted Cumulative Gain (NDCG), which measure the quality of the generated recommendations. In some embodiments, recommendation model trainer 516 uses cross-validation techniques along with early stopping to avoid overfitting. Additionally, recommendation model trainer 516 uses regularization techniques such as dropout, L1 or L2 regularization, and batch normalization for more robustness. Recommendation model trainer 516 is described in more detail in conjunction with FIG. 6B.

Data preparation module 517 processes contextual task-specific data 558 to ensure that the data is in a format suitable for training of recommendation model 559. In various embodiments, data preparation module 517 cleans and normalizes the raw data to address issues, such as missing values, incorrect formatting, inconsistent data types, and/or the like. In some examples, data preparation module 517 prepares features specific to different tasks, such as user interactions, session data, or query context, which are used to make recommendations. For example, in a search task, the data preparation could include extracting features, such as query length or search history, while for recommendation tasks, the data preparation can include preparing contextual task-specific data 558 related to video clicks, user session activity, or content similarity. In at least one embodiment, data preparation includes preparing user and context features by normalizing data, encoding categorical variables, and augmenting the dataset as needed. In some embodiments, data preparation module 517 uses data augmentation techniques, such as creating variations of content interactions or adding noise to ensure recommendation model 559 generalizes well across different tasks.

Feature generation module 518 receives the prepared contextual task-specific data 558 and generates features for use in recommendation model 559. The features include encoded categorical variables, such as content genres, product categories, and/or the like, normalized numerical values, such as session duration, frequency of interactions, and/or the like, and temporal features, such as time spent on specific items and/or the like. In some embodiments, feature generation module 518 performs feature engineering, such as generating interaction features that capture the relationship between user embeddings from user foundation model 560 and contextual task-specific data 558, creating aggregate features that summarize recent user behavior, and/or the like.

Data store 520 can include any storage device or devices, such as fixed disc drive(s), flash drive(s), optical storage, network attached storage (NAS), and/or a storage area-network (SAN). Although shown as accessible over network 530, in some embodiments computing device 510 can include data store 520. As shown, data store 520 is storing, without limitation, user interaction data 557, contextual task-specific data 558, and recommendation model 559.

Recommendation model 559 is a machine learning model, which includes user foundation model 560 and context model 561, and processes user inputs and context inputs generating recommendations. In at least one embodiment, recommendation model 559 also includes a merge layer followed by a dense layer. The merge layer merges the outputs of user foundation model 560 and context model 561. The dense layer further processes the output of the merge layer to generate recommendations.

User foundation model 560 is a machine learning model, which processes user features and generates user embeddings. User features include various user-content interaction data that represent a user's preferences and behaviors on the recommendation platform. User features can include explicit user interactions, such as a user's viewing history, search queries, content likes or ratings, and purchase history, as well as implicit user actions, such time spent on certain content, scrolling behavior, click patterns, and/or the like. For example, a user feature could be the number of times a user has interacted with a particular genre of content or the frequency with which the user engages with recommendations in the evening. User embeddings include vector representations generated from user features that capture the underlying patterns of the user's preferences and habits in a multi-dimensional space. For example, if a user has watched action movies 70% of the time, prefers watching content in the evening, and frequently searches for movies by a particular director, the user features are converted into a user embedding—a multi-dimensional vector such as [0.7, 0.2, 0.8, 0.1, . . . ]—where each dimension of the vector corresponds to a specific aspect of the user's behavior. In the example, the embedding could encode: 0.7 for the preference toward action movies (derived from the feature indicating the user watches action 70% of the time), 0.8 for the evening activity preference (derived from the user feature indicating frequent engagement during that time), 0.2 for interest in a specific director, and 0.1 for less frequent engagement with other genres. In various embodiments, user foundation model 560 is implemented using a deep neural network, such as a transformer-based architecture, a recurrent neural network (RNN), and/or the like

Context model 561 is a machine learning model, which processes context features and generates context embeddings. Context features include various real-time and situational features specific to the task being performed, providing information about the environment in which a recommendation is made. Context features can include explicit contextual data, such as the user's current query, the content or item the user is interacting with, device type, location, time of day, and/or the like, as well as implicit signals, such as session duration, network conditions, recent activity patterns, and/or the like. For example, context features could vary based on the task: in a query-content recommendation task, the context features could include the specific query and relevant metadata; in a content-content recommendation task, the context features could include recently watched content and content similarity; and in a pre-query task, context features could include prior interactions or searches leading up to the current session. Context embeddings are vector representations generated from the context features, encoding the user's immediate environment in a multi-dimensional space. For example, in a query-content recommendation task, if the user is searching for action movies, using a mobile device, and has recently interacted with specific directors, the context features are transformed into a context embedding—a multi-dimensional vector such as [0.7, 0.85, 0.6, 0.3, . . . ]—where each dimension corresponds to a different contextual factor. In the example, the embedding could encode: 0.7 for the relevance of action movies in the query, 0.85 for mobile device usage, 0.6 for interaction with specific directors, and 0.3 for other context features, such as time of day or session length. In various embodiments, context model 561 is implemented using a deep neural network, such as a transformer-based architecture, a CNN, and/or the like, capable of capturing and encoding diverse, task-specific contextual features.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540, without departing from the scope of the present disclosure. For example, the number of processors 542, the number of and/or type of memories 544, and/or the number of applications and or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user inputs and context inputs from input devices (not shown), such as a keyboard or a mouse.

Memory 544 of computing device 540 stores content, such as software applications and data, for use by processor(s) 542. As shown, memory 544 includes, without limitation, a recommendation application 546 and cache 547. Memory 544 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

Cache 547 is a data storage unit which stores user embeddings generated by user foundation model 560. In various embodiments, cache 547 allows the recommendation system to quickly retrieve previously generated user embeddings when the same or similar user features are received, thereby reducing redundant computations and reducing response time. Cache 547 typically stores user embeddings in a structured format, such as a key-value dictionary and/or the like, where the keys represent the unique user features (or a hashed representation of the user features) and the values correspond to the precomputed user embeddings. The structured format allows for fast lookups by matching incoming user features with existing entries in cache 547. For example, in a query-content recommendation task, the key could represent a hashed combination of the user's query, such as “action movies” and device type, while the value could store the corresponding precomputed user embedding. When a user submits the same or similar query, the recommendation system can retrieve the corresponding user embeddings without processing the query with user foundation model 560.

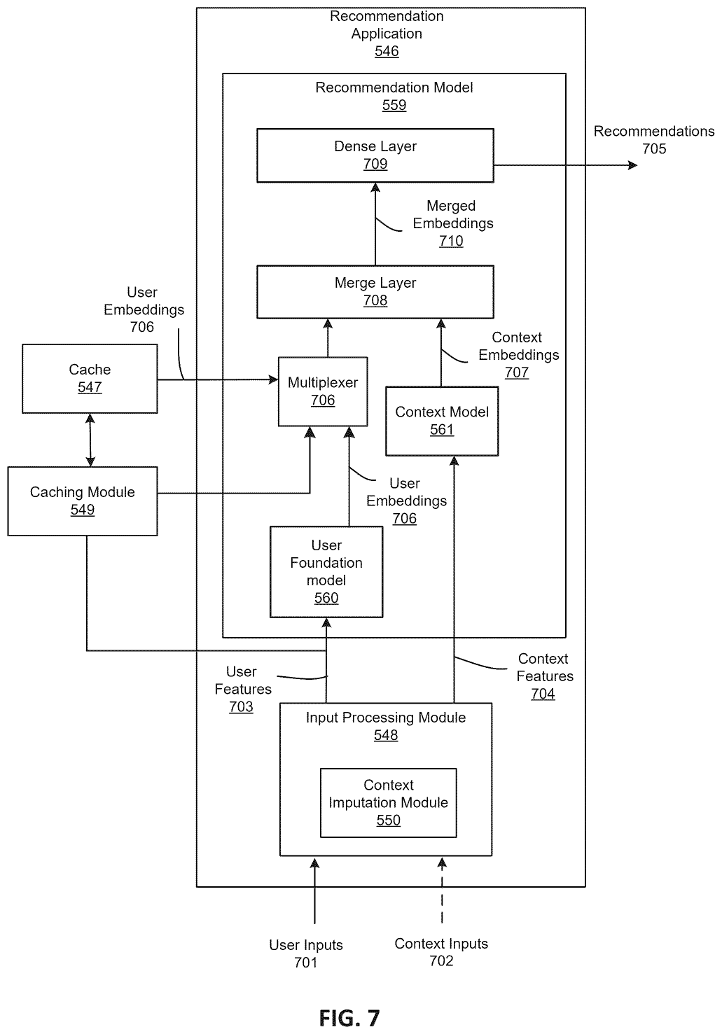

Recommendation application 546 processes user inputs and context inputs and generates recommendations. As shown, recommendation application 546 includes, without limitation, input processing module 548 and caching module 549. User inputs include, without limitation, real-time interactions, such as clicks, searches, likes, plays, and other immediate user activities on the platform. In some embodiments, context inputs are related to the specific task at hand and provide additional information about the user's environment and session. Context inputs can vary based on the nature of the recommendation task, including but not limited to device type, time of day, session length, and the specific content or product currently being interacted with. For example, in a query-content recommendation task, context inputs could include the user's search query, location, and the time of day, whereas in a content-content recommendation task, the context could focus more on recent user interactions, content history, or content similarity. In pre-query tasks, context inputs such as the user's browsing behavior or past searches. In various embodiments, recommendation application 546 receives user inputs through various I/O devices (not shown), including direct interactions, browsing activity, and implicit feedback, such as engagement duration, skipped items, and/or the like. Context inputs are captured through various channels, such as clickstream data, which tracks each user clicks and tracking scripts (e.g. JavaScript or similar technologies embedded in the recommendation platform), which record user page navigation or hovering over content. On the backend, server logs can capture context inputs by logging user requests, including search queries, page loads, and API calls. In some embodiments, by dynamically analyzing and processing the real-time user inputs and context inputs, recommendation application 546 ensures that the generated recommendations are relevant and personalized to the user's ongoing behavior and task context. Recommendation application 546 is described in more detail in conjunction with FIG. 7.

Input processing module 548 processes user inputs and context inputs to generate user features and context features. As shown, input processing module 548 includes, without limitation a context imputation module 550. Input processing module 548 receives raw data from various user inputs and context inputs and processes the data into a structured format suitable for use by the trained recommendation model 559. The processing includes, without limitation, handling missing or inconsistent data, normalizing numerical values (e.g., session length, interaction frequency), and encoding categorical variables (e.g., content genres, product types) into formats that can be used by the trained recommendation model 559. In some embodiments, input processing module 548 performs pre-processing tasks, such as feature scaling or standardization.

Context imputation module 550 imputes context inputs when context inputs are missing or incomplete. In various embodiments, context imputation module 550 imputes missing context inputs using either heuristic-based approaches, machine learning techniques, and/or the like. For example, using heuristics, if the time of interaction is missing, context imputation module 550 can impute time of the day based on typical user behavior patterns or default assumptions, such as assuming that users generally engage with content in the evening. On the other hand, context imputation module 550 can use machine learning models which predict missing context inputs by learning from historical data. For example, if the device type is not recorded during a session, a machine learning model can analyze previous sessions of the same user or similar users to predict the likely device being used.

Caching module 549 caches user embeddings to reduce latency of recommendation application 546. In various embodiments, when user features are received, caching module 549 first checks if the corresponding user embeddings have been previously generated by the user foundation model 560 and stored in cache 547. If available, the cached user embeddings are retrieved from cache 547, reducing the need for redundant computations and speeding up the response time for generating recommendations. In some embodiments, caching module 549 uses least-recently-used (LRU) or time-based expiration to ensure that cache 547 stores the most relevant user embeddings while managing memory resources of cache 547.

### Training the Recommendation Model

FIG. 6A is a more detailed illustration of the user foundation model trainer 515, according to various embodiments. As shown, user foundation model 515 uses user interaction data 557 to train user foundation model 560.

In operation, user foundation model trainer 515 prepares user interaction data 557 by splitting user interaction data 557 into training, validation, and test datasets, ensuring that the test dataset remains separate from the training and validation sets to maintain unbiased evaluation. Negative samples are also included in the dataset, which represent content or products the user has not interacted with, helping user foundation model trainer 515 to train user foundation model 560 to differentiate between preferred and non-preferred content. During the training process, user foundation model trainer 515 optimizes the parameters of user foundation model 560 using various techniques, such as SGD, Adam optimizer, RMSProp, and/or the like, by minimizing a loss function, such as cross entropy loss, and generate user embeddings. In various embodiments, to avoid overfitting and ensure user foundation model 560 generalizes well across various tasks, user foundation model trainer 515 uses regularization methods, such as dropout, L2 regularization, batch normalization, and/or the like. In some examples, user foundation model 560 can be pre-trained on user interaction data 557 and later fine-tuned using task-specific data for recommendation tasks. In various embodiments, user foundation model trainer 515 trains user foundation model 560 in multiple cycles, where cross-validation and early stopping are employed to further refine user foundation model 560. Once trained, user foundation model 560 generates user embeddings that are used in recommendation model 559.

FIG. 6B is a more detailed illustration of the recommendation model trainer 516, according to various embodiments. As shown, recommendation model trainer 516 uses contextual task specific data 558 to train recommendation model 559.

In operation, recommendation model trainer 516 begins the training process by freezing the parameters of the trained user foundation model 560. Data preparation module 517 then prepares contextual task-specific data 558 to ensure contextual task-specific data 558 is formatted correctly for training. In some embodiments, data preparation module 517 cleans, normalizes, and augments contextual task-specific data 558 to address issues, such as missing values, incorrect formats, and inconsistent data types. Once the data is prepared, feature generation module 518 processes the prepared contextual task-specific data 558 and generates relevant features for use in recommendation model 559. The features include encoded categorical variables, normalized numerical values, and temporal features. Additionally, feature generation module 518 generates interaction features that capture the relationship between user embeddings from user foundation model 560 and contextual task-specific data 558, as well as aggregate features that summarize recent user behavior. With the processed features, recommendation model trainer 516 uses techniques, such as SGD, to optimize the parameters of context model 561 and other parameters of recommendation model 559, such as the parameters of a merge layer and a dense layer, for specific recommendation tasks. In various embodiments, recommendation model trainer 516 minimizes task-specific loss functions, such as a binary cross-entropy loss function, and optimizes the parameters of recommendation model 559 to improve content recommendation performance across various tasks. During training, recommendation model trainer 516 evaluates recommendation model 559 using ranking metrics, such as NMRR, NDCG, and/or the like. In some embodiments, throughout training, recommendation model trainer 516 uses regularization techniques, such as dropout, L1 or L2 regularization, batch normalization, and/or the like, to prevent overfitting and improve the robustness of recommendation model 559. Additionally, recommendation model trainer 516 uses various techniques, such as cross-validation and early stopping, to ensure that recommendation model 559 generalizes well to new user interactions while maintaining high accuracy across different recommendation tasks.

### Personalized Recommendations Using the Recommendation Model

FIG. 7 is a more detailed illustration of the recommendation application 546, according to various embodiments. As shown, recommendation application 546 uses the trained recommendation model 559 to process user inputs 701 and context inputs 702 and generates recommendations 705. As shown, recommendation application 546 includes, without limitation, recommendation model 559 and input processing module 548. Input processing module 548 includes, without limitation, context imputation module 550. Recommendation model 559 includes, without limitation, user foundation model 560, context model 561, multiplexer 706, merge layer 708, and dense layer 709.

Input processing module 548 processes user inputs 701 and context inputs 702 and generates user features 703 and context features 704. In some embodiments, the processing includes normalizing numerical values (e.g., converting session duration into a consistent format), and/or the like. For example, normalizing numerical values could include converting varying time-based inputs, such as session duration or time spent on specific content, into a consistent format (e.g., minutes or seconds). In addition to normalization, input processing module 548 encodes categorical variables, transforming inputs such as device type (e.g., mobile, desktop, or tablet), content genres (e.g., drama, action, comedy), and page identifiers (e.g., homepage, genre page, search results page) into numerical representations. For example, a device type could be one-hot encoded as a vector: [1, 0, 0] for mobile, [0, 1, 0] for tablet, and so on. In at least one embodiment, input processing module 548 applies feature scaling to numerical user inputs 701, such as interaction frequency (e.g., the number of clicks a user has made on similar content), ensuring that all numerical values are scaled to a consistent range, typically between 0 and 1, to prevent some values from disproportionately influencing the predictions of the trained recommendation model 559.

If context inputs 702 are missing or incomplete, context imputation module 550 included in input processing module 548 imputes the missing or incomplete context. In various embodiments, context imputation module 550 imputes missing or incomplete context inputs 702 using heuristic-based and/or machine learning techniques, depending on the specific context inputs 702 that are absent. For example, in a search task, if a user performs a query and there is no associated source title identifier (e.g., the title the user is searching from), context imputation module 550 imputes the missing title context input 702 as a null value. In a title-to-title recommendation task, where recommendation application 546 recommends content based on a source title, context imputation module 550 could extract additional contextual information such as the English description of the title, ensuring that local-specific descriptions are considered. For example, when the context inputs 702 includes a title like Stranger Things, context imputation module 550 imputes the query context to “Stranger Things” and enrich the context with relevant details, such as the genre or theme. If the time of day is missing from context inputs 702, context imputation module 550 could apply a heuristic approach by assuming that the user is interacting with the platform during typical user engagement times, such as in the evening or during weekends, based on historical user interaction data. Similar to time of the day, if the device type is missing from context inputs 702, context imputation module 550 could use a machine learning model that has been trained on previous sessions from the same user or similar users. The machine learning model could predict the most probable device type based on historical patterns, such as whether the user frequently accesses content on a mobile device during specific times of the day.

Recommendation model 559 processes user features 703 and context features 704 and generates recommendations 705. For example, recommendation 705 can be a probability score for positive engagement with content. User foundation model 560 included in recommendation model 559 processes user features 703 and generates user embeddings 706. Context model 561 included in recommendation model 559 processes context features 704 and generates context embeddings 707.

Caching module 549 caches user embeddings 706 to reduce latency. In various embodiments, caching module 549 checks if the corresponding user features 703 have already been processed by user foundation model 560 and if the resulting user embeddings 706 have been stored in cache 547. In some embodiments, caching module 549 checks by hashing or using unique identifiers for the user features 703. The user features 703 can include, without limitation, past viewing behavior, preferred genres, or frequently interacted content, and matching user features 703 with stored entries in cache 547. If the hash or unique identifier of the current user features 703 matches an existing entry in cache 547, caching module 549 retrieves the precomputed and cached user embeddings 706 from cache 547, bypassing the need to recompute user embeddings 706 through user foundation model 560. As shown, caching module 549 interacts with multiplexer 706, which selects the source of user embeddings 706 that are sent to merge layer 708. If caching module 549 retrieves user embeddings 706 from cache 547, caching module 549 signals multiplexer 706 to select the cached user embeddings 706. Conversely, if the user features 703 have not been processed before (e.g., if caching module 549 could not find a match in cache 547), caching module 549 signals multiplexer 706 to select user embeddings 706 generated from user foundation model 560. Then, user foundation model 560 processes the new user features 703 to generate new user embeddings 706. For example, if a user switches from watching action movies to romantic comedy movies—a genre the user have not engaged with before—multiplexer 706 could select user embeddings 706 generated by user foundation model 560, as no cached user embeddings 706 for romantic comedy genre exist in cache 547. The new user embeddings 706 are then stored in cache 547 so that the next time the user engages with romantic comedies, caching module 549 can retrieve user embeddings 706 from cache 547, and multiplexer 706 can select the cached user embeddings 706. Additionally, caching module 549 uses techniques, such as LRU or time-based expiration, to manage memory resources. If cache 547 is full, older or less frequently accessed user embeddings 706, such as the for genres the user has not interacted with recently, are removed to make space for new user embeddings 706. For example, if the user has not watched documentaries for a long time, the corresponding user embeddings 706 could be removed from cache 547 in favor of more relevant user embeddings 706.

Merge layer 708 merges user embeddings 706 and context embeddings 707 and generates merged embeddings 710. In some examples, merge layer 708 can be implemented as part of a deep neural network. In some embodiments, merge layer 708 uses concatenation to merge user embeddings 706 and context embeddings 707, where user embeddings 706 and context embeddings 707 are concatenated into a single, larger vector of merged embeddings 709. For example, if user embeddings 706 are a 128-dimensional vector and context embeddings 707 are a 64-dimensional vector, the result of concatenation, merged embeddings 709, could be a 192-dimensional vector, retaining information from both user embeddings 706 and context embeddings 707. In various embodiments, merge layer 708 uses element-wise operations, such as element-wise multiplication or addition, to merge user embeddings 706 and context embeddings 707. For example, element-wise multiplication could combine the corresponding elements of user embeddings 706 and context embeddings 707 to capture the interactions between the two, which is useful when certain user preferences interact with specific contextual factors, such as the user's favorite genres being more relevant at specific times of day. In some embodiments, merge layer 708 uses feature crossing, where combinations of features from the user embeddings 706 and context embeddings 707 are created. For example, the interaction between a user's preference for action movies and the current time of day could be crossed to represent a more specific viewing pattern, such as a tendency to watch action movies in the evening.

Dense layer 709 processes merged embeddings 710 and generates recommendations 705. In some examples, dense layer 709 can be implemented as part of a deep neural network. In various embodiments, dense layer 709 uses various fully connected layers to process merged embeddings 709. During the processing of merged embeddings 709, each layer in the network applies a weighted sum to the input, followed by a non-linear activation function, such as Rectified Linear Unit (ReLU), sigmoid, and/or the like. In at least one embodiment, dense layer 709 includes residual connections between the layers to allow the input of one layer to be directly added to the output of a deeper layer, which prevents the loss of information during transformations. For example, if the first dense layer applies ReLU or sigmoid transformations to merged embeddings 709, residual connections can add merged embeddings 710 (before the ReLU or sigmoid transformation) to the output of a later layer. In at least one embodiment, dense layer 709 uses a softmax layer to further process merged embeddings 709, which generates a probability distribution over possible recommendations 705.

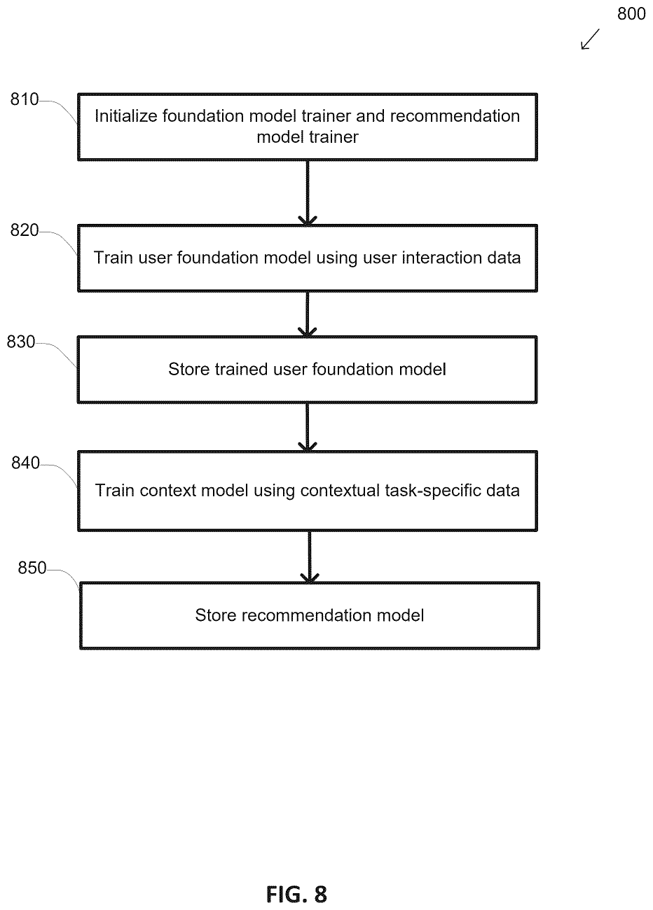

FIG. 8 sets forth a flow diagram of method steps for training the recommendation model 559, according to various embodiments. Although the method steps are described in conjunction with the systems of FIGS. 5, 6A, 6B and 8, persons skilled in the art will understand that any system configured to perform the method steps in any order falls within the scope of the present disclosure.

A method 800 begins with step 810 where user foundation model trainer 515 and recommendation model trainer 516 are initialized. The initialization process includes setting the parameters of user foundation model 560 and context model 561, which can be initialized randomly, using techniques, such as Xavier initialization, He initialization (also known as Kaiming initialization), and/or the like, to ensure that weights are distributed appropriately for training. Additionally, the initialization includes configuring optimization algorithms such as SGD or the Adam optimizer. The initialization of SGD includes initializing hyperparameters, such as the learning rate, momentum, which helps accelerate gradients, and batch size. The initialization of the Adam optimizer includes initializing hyperparameters, such as learning rates, beta values, and epsilon, to control the adaptation during training. The initialization also includes setting up an adaptable learning rate scheduler with a learning rate that dynamically adjusts during training (e.g., ranging from 0.0001 to 0.1) so that the learning rate decreases over time as training of recommendation model 559 progresses. In some embodiments, hyper-parameter optimization is performed beforehand to determine the optimal values, ensuring that the user foundation model 560 and recommendation model 559 can be trained while avoiding overfitting or slow training. Moreover, user interaction data 557 is split into training, validation, and test datasets. The split can be done randomly or using specific techniques, such as stratified splitting, time-based splitting, and k-fold cross validation, to maintain a balanced distribution of various user behaviors.

At step 820, user foundation model trainer 515 trains user foundation model 560 using user interaction data 557. During the training process, user foundation model trainer 515 optimizes the parameters of user foundation model 560 using optimization techniques, such as SGD, Adam optimizer, or RMSProp, minimizing a loss function, such as cross-entropy loss function. To prevent overfitting and ensure generalization, user foundation model trainer 515 uses regularization techniques, such as dropout, L2 regularization, and batch normalization. In various embodiments, user foundation model trainer 515 trains user foundation model 560 in multiple cycles, using techniques, such as cross-validation, to evaluate performance on various subsets of data, and early stopping to prevent overfitting.

At step 830, user foundation model trainer 515 stores the trained user foundation model 560. In various embodiments, after training, user foundation model trainer 515 stores the trained user foundation model 560 in data store 520. The trained user foundation model 515 is used to process user features 703 and generate user embeddings 706 during the training of context model 561 in the next step.

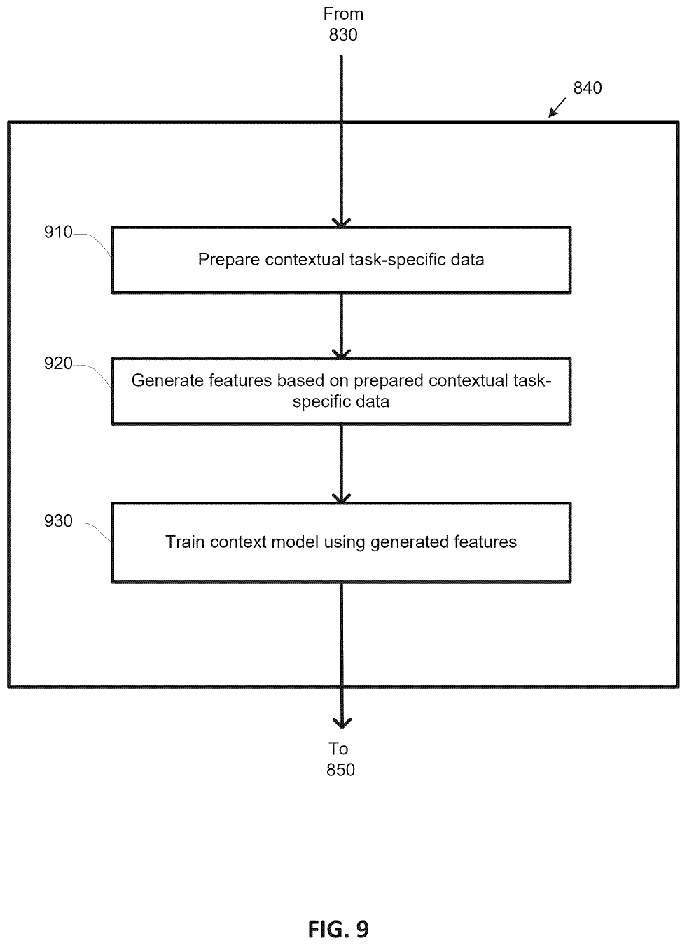

At step 840, recommendation model trainer 516 trains context model 561 using contextual task-specific data 558. In various embodiments, recommendation model trainer 516 freezes the parameters of user foundation model 560 trained in step 830. Data preparation module 517 prepares contextual task-specific data 558 for training. Feature generation module 518 processes prepared contextual task-specific data 558 and generates features. Recommendation model trainer 516 uses the generated features to train context model 561 and the rest of the parameters of recommendation model 559, which include the parameters of merge layer 708 and dense layer 709. Step 840 is described in more detail in conjunction with FIG. 9.

At step 850, recommendation model trainer 516 stores recommendation model 559. In various embodiments, recommendation model trainer 516 stores the trained recommendation model 559 in data store 520 for access by other computing devices, such as computing device 540.

FIG. 9 sets forth a flow diagram of method steps for training the context model 561, according to various embodiments. Although the method steps are described in conjunction with the systems of FIGS. 5, 6B, and 9, persons skilled in the art will understand that any system configured to perform the method steps in any order falls within the scope of the present disclosure.

Step 840 begins with step 910, where data preparation module 517 prepares contextual task-specific data 558. In various embodiments, data preparation module 517 cleans, normalizes, and/or formats contextual task-specific data 558 to ensure contextual task-specific data 558 is structured for training. The preparation process addresses issues, such as missing values, incorrect formatting, and inconsistent data types. In at least one embodiment, data preparation module 517 augments the contextual task-specific data 558 to improve model generalization, for example, by applying transformations or adding noise.

At step 920, feature generation module 518 generates features based on prepared contextual task-specific data 558. In various embodiments, feature generation module 518 encodes categorical variables, normalizes numerical values, and/or generates temporal features to ensure the prepared contextual task-specific data 558 is in a form suitable for training recommendation model 559. In some embodiments, feature generation module 518 performs feature engineering by creating interaction features that capture relationships between user embeddings 706 from user foundation model 560 and contextual task-specific data 558. In at least one embodiment, feature generation module 518 generates aggregate features summarizing user behavior over time to improve the ability of recommendation model 559 to capture patterns and trends relevant to various tasks.

At step 930, recommendation model trainer 516 trains context model 561 using generated features. In various embodiments, recommendation model trainer 516 trains context model 561, merge layer 708, and dense layer 709 using the generated features at step 920. In some embodiments, the training process includes optimizing the parameters of context model 561 and other components of recommendation model 559, such as merge layer 708 and dense layer 709, using techniques, such as SGD. During training, recommendation model trainer 516 minimizes task-specific loss functions, such as binary cross-entropy loss function, to improve the recommendation performance. Recommendation model trainer 516 also applies regularization techniques, such as dropout, L1 or L2 regularization, and batch normalization, to prevent overfitting and improve the robustness of recommendation model 559. In at least one embodiment, recommendation model trainer 516 evaluates the recommendation performance of recommendation model 559 using ranking metrics, such as NMRR and NDCG, to ensure recommendation model 559 generates accurate recommendations. In at least one embodiment, recommendation model trainer 516 uses cross-validation and early stopping techniques to enhance generalization and avoid overfitting across different recommendation tasks.

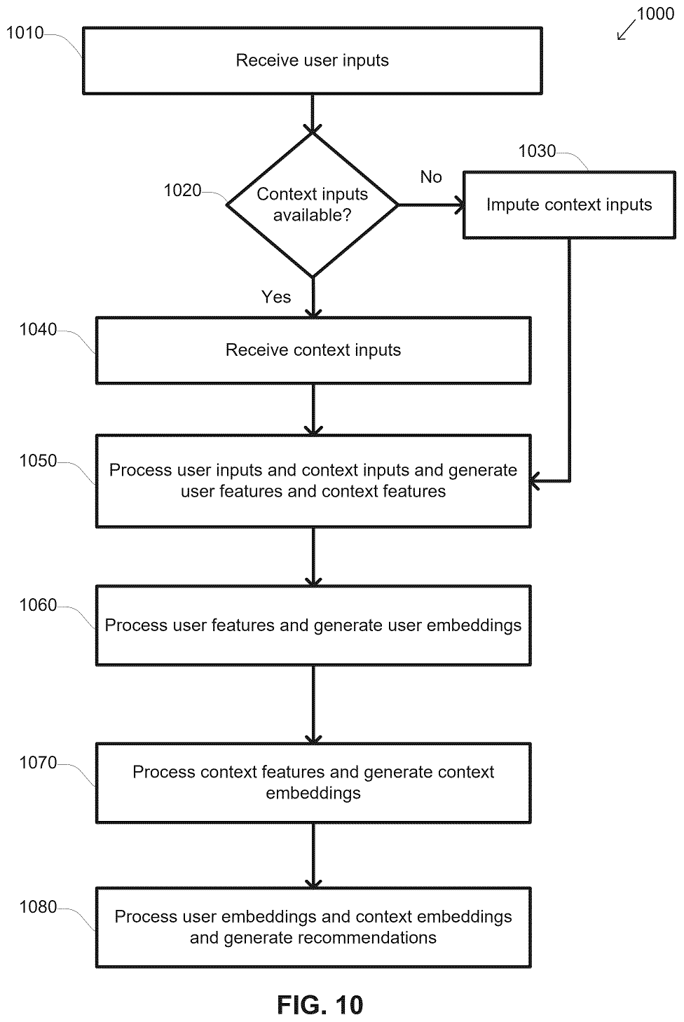

FIG. 10 sets forth a flow diagram of method steps for generating recommendations 705, according to various embodiments. Although the method steps are described in conjunction with the systems of FIGS. 5, 7, and 10, persons skilled in the art will understand that any system configured to perform the method steps in any order falls within the scope of the present disclosure.

A method 1000 begins with step 1010, where recommendation application 546 receives user inputs 701. In various embodiments, recommendation application 546 receives user inputs 701 through various input channels, including real-time interactions such as clicks, searches, likes, plays, and other immediate user activities on the recommendation platform. Additionally, user inputs 701 can be received as the user interacts with different content and/or performs actions within the recommendation platform's user interface. In some embodiments, recommendation application 546 receives user inputs 701 via voice commands, typed queries, and/or the like. In at least one embodiment, recommendation application 546 receives implicit user inputs 701, such as engagement duration, scrolling behavior, and/or skipped content.

At step 1020, context imputation module 550 checks if context inputs 702 are available. If context inputs 702 are not available the method proceeds to step 1030. If context inputs 702 are available, the method proceeds to step 1040.

At step 1030, context imputation module 550 imputes context inputs 702. In various embodiments, context imputation module 550 handles missing or incomplete context inputs 702 by using heuristic-based or machine learning techniques, depending on the specific nature of the missing data. For example, in a search task, if a source title identifier is missing, context imputation module 550 imputes a null value. In title-to-title recommendation tasks, context imputation module 550 enriches the missing context by extracting relevant information, such as a title's description or genre. If context inputs 702 lack information, such as the time of day, context imputation module 550 applies a heuristic approach, assuming typical user engagement times based on historical data. For missing device type information, context imputation module 550 uses machine learning models trained on previous user sessions and/or similar users to predict the most probable device type

At step 1040, recommendation application 546 receives context inputs 702. Context inputs 702 can include information such as the source UI page from which the interaction originates, and content qualifiers for the search, such as specific genres, keywords, or metadata. In various embodiments, context inputs 702 can be received through various input channels, including clickstream data, tracking scripts embedded in the recommendation platform, and server logs.

At step 1050, input processing module 548 processes user inputs 701 and context inputs 702 and generates user features 703 and context features 704. In various embodiments, input processing module 548 processes user inputs 701 and context inputs 702 by normalizing numerical values and encoding categorical variables to ensure consistency in the data. In some embodiments, input processing module 548 applies transformations, such as feature scaling to ensure that numerical values are within a consistent range. Additionally, input processing module 548 encodes categorical data into numerical representations.

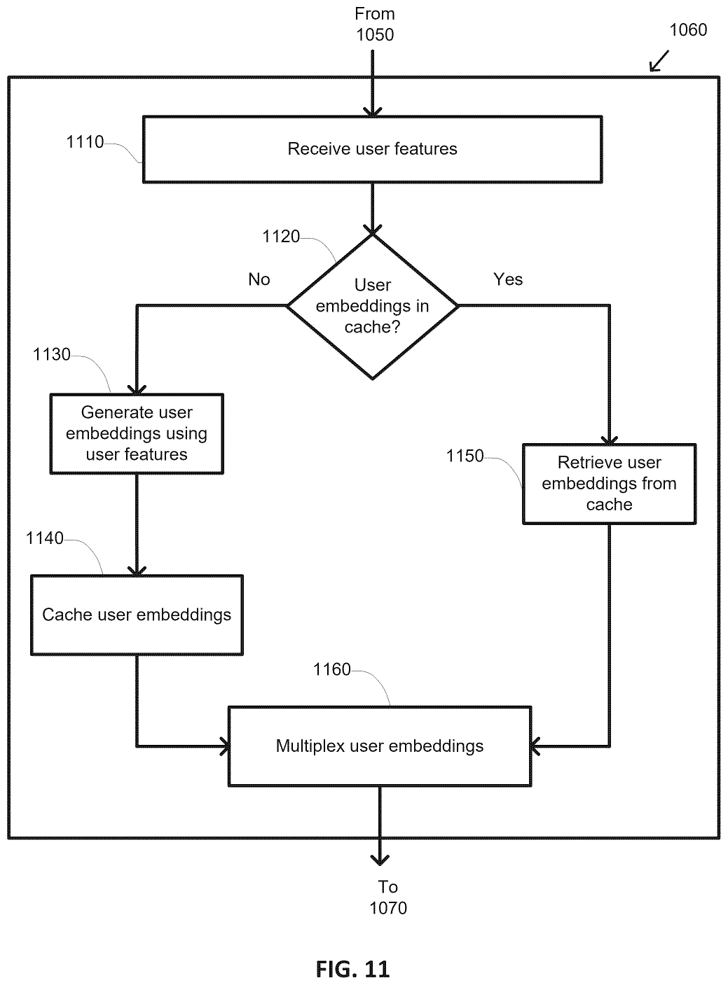

At step 1060, user foundation model 560 processes user features 703 and generate user embeddings 706. In some embodiments, caching module 549 checks whether user embeddings 706 have already been computed and stored in cache 547, reducing the need for user embeddings 706 to be generated by user foundation model 560. Step 1060 is described in more detail in conjunction with FIG. 11.

At step 1070, context model 561 processes context features 704 and generates context embeddings 707. In various embodiments, context model 561 transforms context features 704 into multi-dimensional vector representations. In various embodiments, steps 1060 and 1070 can be performed concurrently or in a different order.

At step 1080, recommendation model 559 processes user embeddings 706 and context embeddings 707 and generates recommendations 705. In various embodiments, merge layer 708 merges user embeddings 706 and context embeddings 707 generating merged embeddings 709. Dense layer 709 then processes merged embeddings 710 and generates recommendations 705. In various embodiments, merge layer 708 merges user embeddings 706 and context embeddings 707 through concatenation, element-wise operations, and/or feature crossing to combine user and context information into a single representation. In at least one embodiment, dense layer 709 then processes merged embeddings 709, applying fully connected layers that use weighted sums and non-linear activation functions, such as ReLU or sigmoid. In some embodiments, dense layer 709 includes residual connections to preserve information through deeper layers and can apply a softmax layer to generate a probability distribution, which is used to generate recommendations 705.

FIG. 11 sets forth a flow diagram of method steps for processing user features 703 and generating user embeddings 706, according to various embodiments. Although the method steps are described in conjunction with the systems of FIGS. 7 and 11, persons skilled in the art will understand that any system configured to perform the method steps in any order falls within the scope of the present disclosure.

As shown step 1060 begins with step 1110, where caching module 549 receives user features 703. In various embodiments, caching module 549 receives user features 703 generated by input processing module 548 at step 1050.

At step 1120, caching module 549 checks whether user embeddings 706 are available in cache 547. In various embodiments, user embeddings 706 are stored in cache 547 in a structured format, such as a key-value dictionary, where the keys represent the unique user features 703 and/or a hashed representation of user features 703, and the values correspond to the precomputed user embeddings 706. When user features 703 are received, caching module 549 searches for the corresponding user embeddings 706 by matching the incoming user features 703 with the keys in cache 547. If user embeddings 706 are available in cache 547, step 1060 proceeds to step 1150. If user embeddings 706 are not available in cache 547, the step 1060 proceeds to step 1130.

At step 1130, user foundation model 560 generates user embeddings 706 using user features 703. In various embodiments, user foundation model 560 processes user features 703 and generates user embeddings 706. Method 1000 then proceeds to step 1050.

At step 1140, caching module 549 caches user embeddings 706. In various embodiments, caching module 549 caches user embeddings 706 generated at step 1130, which have not been stored in cache 547. User embeddings 706 are stored in a structured format, such as a key-value dictionary, where the keys represent the unique user features 703 and/or a hashed representation of user features 703, and the values correspond to the newly generated user embeddings 706. In some embodiments, caching module 549 uses cache management techniques, such as LRU or time-based expiration, to ensure that cache 547 remains within storage capacity by removing older or less frequently accessed entries to make space for new user embeddings 706.

At step 1150, caching module 549 retrieves user embeddings 706 from cache 547. In various embodiments, caching module 549 performs a lookup in cache 547 using the user features 703 or a hashed representation of user features 703 as keys. If a matching entry is found, caching module 549 retrieves the corresponding user embeddings 706 stored as values in cache 547.

At step 1160, multiplexer 706 multiplexes user embeddings 706. In various embodiments, caching module 549 interacts with multiplexer 706 to select the source of user embeddings 706. If caching module 549 retrieves user embeddings 706 from cache 547 using step 1150, caching module 549 signals multiplexer 706 to select the retrieved user embeddings 706 from cache 547 at step 1150. Conversely, if caching module 549 cannot find a match in cache 547, caching module 549 signals multiplexer 706 to select user embeddings 706 generated by user foundation model 560 at step 1130.

1. In some embodiments, a computer-implemented method for generating recommendations using a recommendation model comprises receiving one or more user inputs, determining one or more context features based on one or more context inputs, determining one or more user features based on the one or more user inputs, determining one or more user embeddings based on the one or more user features, determining one or more context embeddings based on the one or more context features, merging the one or more user embeddings and the one or more context embeddings to generate one or more merged embeddings, and generating recommendations based on the one or more merged embeddings.

2. The computer-implemented method of clause 1, wherein the recommendation model further comprises a first model, which processes the one or more user features and generates the one or more user embeddings, a second model, which processes the one or more context inputs and generates the one or more context embeddings, a merge layer, which processes the one or more user embeddings and the one or more context embeddings and generates the one or more merged embeddings, and a dense layer, which processes the one or more merged embeddings and generates the recommendations.

3. The computer-implemented method of clauses 1 or 2, wherein the first model is a user foundation model.

4. The computer-implemented method of any of clauses 1-3, wherein the recommendation model is trained by performing one or more operations to train the first model of the recommendation model based on user interaction data, freezing parameters of the first model after training the first model, and training the second model, the merge layer, and the dense layer of the recommendation model based on contextual task-specific data.

5. The computer-implemented method of any of clauses 1-4, wherein training the second model, the merge layer, and the dense layer of the recommendation model based on conceptual task-specific data further comprises optimizing the parameters of the second model, the merge layer, and the dense layer using an Adam optimizer and a binary cross-entropy loss function, and evaluating the recommendation model using one or more ranking metrics.

6. The computer-implemented method of any of clauses 1-5, wherein evaluating the recommendation model using of the one or more ranking metrics comprises using at least one of a normalized mean reciprocal rank or a normalized discounted cumulative gain.

7. The computer-implemented method of any of clauses 1-6, wherein determining the one or more context features based on the one or more context inputs further comprises in response to determining that the one or more context inputs are not available, imputing the one or more context inputs.

8. The computer-implemented method of any of clauses 1-7, wherein imputing the one or more context inputs comprises applying a plurality of heuristics.

9. The computer-implemented method of any of clauses 1-8, wherein the plurality of heuristics comprises at least one of assigning a null value to title context input when a source title is missing, enriching the missing context by extracting relevant information from a source title, or extracting context input based on typical user engagement determined from historical user interaction data.

10. The computer-implemented method of any of clauses 1-9, wherein determining the one or more user embeddings based on the one or more user features further comprises in response to determining that the one or more user embeddings are not cached generating, using a user foundation model, the one or more user embeddings based on the one or more user features, and caching the one or more user embeddings.

11. The computer-implemented method of any of clauses 1-10, wherein determining the one or more user embeddings based on the one or more user features further comprises in response to determining that the one or more user embeddings are cached, retrieving one or more user embeddings from the cache.

12. The computer-implemented method of any of clauses 1-11, where merging the one or more user embeddings and the one or more context embeddings to generate one or more merged embeddings further comprises at least one of concatenation, element-wise multiplication, or feature crossing.

13. The computer-implemented method of any of clauses 1-12, where generating recommendations based on the one or more merged embeddings further comprises using residual connections in a dense layer of the recommendation model.

14. In some embodiments, a non-transitory computer-readable medium stores instructions that, when executed by one or more processors, cause the one or more processors to perform a method for generating recommendations using a recommendation model comprises receiving one or more user inputs, determining one or more context features based on one or more context inputs, determining one or more user features based on the one or more user inputs, determining one or more user embeddings based on the one or more user features, determining one or more context embeddings based on the one or more context features, merging the one or more user embeddings and the one or more context embeddings to generate one or more merged embeddings, and generating recommendations based on the one or more merged embeddings.

15. In some embodiments, a non-transitory computer-readable medium of clause 14, wherein the recommendation model further comprises a first model, which processes the one or more user features and generates the one or more user embeddings, a second model, which processes the one or more context inputs and generates the one or more context embeddings, a merge layer, which processes the one or more user embeddings and the one or more context embeddings and generates the one or more merged embeddings, and a dense layer, which processes the one or more merged embeddings and generates the recommendations.

16. In some embodiments, a non-transitory computer-readable medium of clause 15, wherein the first model is a user foundation model.

17. In some embodiments, a non-transitory computer-readable medium of clause 16, wherein determining the one or more context features based on the one or more context inputs further comprises in response to determining that the one or more context inputs are not available, imputing the one or more context inputs.

18. In some embodiments, a non-transitory computer-readable medium of clause 17, wherein imputing the one or more context inputs comprises applying a plurality of heuristics, the plurality of heuristics comprises at least one of assigning a null value to the title context input when a source title is missing, enriching the missing context by extracting relevant information from a source title, or extracting context input based on typical user engagement determined from historical user interaction data.

19. In some embodiments, a non-transitory computer-readable medium of claim 14, wherein determining the one or more user embeddings based on the one or more user features further comprises in response to determining that the one or more user embeddings are not cached generating, using a user foundation model, the one or more user embeddings based on the one or more user features and caching the one or more user embeddings, and in response to determining that the one or more user embeddings are cached, retrieving one or more user embeddings from the cache.

20. In some embodiments, a system comprises one or more memories storing instructions, and one or more processors that are coupled to the one or more memories and, when executing the instructions, are configured to receiving one or more user inputs, determining one or more context features based on one or more context inputs, determining one or more user features based on the one or more user inputs, determining one or more user embeddings based on the one or more user features, determining one or more context embeddings based on the one or more context features, merging the one or more user embeddings and the one or more context embeddings to generate one or more merged embeddings, and generating recommendations based on the one or more merged embeddings.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating recommendations using a recommendation model, the method comprising:
receiving one or more user inputs;
determining one or more context features based on one or more context inputs;
determining one or more user features based on the one or more user inputs;
determining one or more user embeddings based on the one or more user features;
determining one or more context embeddings based on the one or more context features;
merging the one or more user embeddings and the one or more context embeddings to generate one or more merged embeddings; and
generating recommendations based on the one or more merged embeddings.

2. The computer-implemented method of claim 1, wherein the recommendation model further comprises:
a first model, which processes the one or more user features and generates the one or more user embeddings;
a second model, which processes the one or more context inputs and generates the one or more context embeddings;
a merge layer, which processes the one or more user embeddings and the one or more context embeddings and generates the one or more merged embeddings; and
a dense layer, which processes the one or more merged embeddings and generates the recommendations.

3. The computer-implemented method of claim 2, wherein the first model is a user foundation model.

4. The computer-implemented method of claim 2, wherein the recommendation model is trained by:
performing one or more operations to train the first model of the recommendation model based on user interaction data;
freezing parameters of the first model after training the first model; and
training the second model, the merge layer, and the dense layer of the recommendation model based on contextual task-specific data.

5. The computer-implemented method of claim 4, wherein training the second model, the merge layer, and the dense layer of the recommendation model based on conceptual task-specific data further comprises:
optimizing the parameters of the second model, the merge layer, and the dense layer using an Adam optimizer and a binary cross-entropy loss function; and
evaluating the recommendation model using one or more ranking metrics.

6. The computer-implemented method of claim 5, wherein evaluating the recommendation model using of the one or more ranking metrics comprises using at least one of a normalized mean reciprocal rank or a normalized discounted cumulative gain.

7. The computer-implemented method of claim 1, wherein determining the one or more context features based on the one or more context inputs further comprises in response to determining that the one or more context inputs are not available, imputing the one or more context inputs.

8. The computer-implemented method of claim 7, wherein imputing the one or more context inputs comprises applying a plurality of heuristics.

9. The computer-implemented method of claim 8, wherein the plurality of heuristics comprises at least one of:
assigning a null value to title context input when a source title is missing;
enriching the missing context by extracting relevant information from a source title; or
extracting context input based on typical user engagement determined from historical user interaction data.

10. The computer-implemented method of claim 1, wherein determining the one or more user embeddings based on the one or more user features further comprises in response to determining that the one or more user embeddings are not cached:
generating, using a user foundation model, the one or more user embeddings based on the one or more user features; and
caching the one or more user embeddings.

11. The computer-implemented method of claim 1, wherein determining the one or more user embeddings based on the one or more user features further comprises in response to determining that the one or more user embeddings are cached, retrieving one or more user embeddings from the cache.

12. The computer-implemented method of claim 1, where merging the one or more user embeddings and the one or more context embeddings to generate one or more merged embeddings further comprises at least one of concatenation, element-wise multiplication, or feature crossing.

13. The computer-implemented method of claim 1, where generating recommendations based on the one or more merged embeddings further comprises using residual connections in a dense layer of the recommendation model.

14. A non-transitory computer-readable medium storing instructions that, when executed by one or more processors, cause the one or more processors to perform a method for generating recommendations using a recommendation model, the method comprising:
receiving one or more user inputs;
determining one or more context features based on one or more context inputs;
determining one or more user features based on the one or more user inputs;
determining one or more user embeddings based on the one or more user features;
determining one or more context embeddings based on the one or more context features;
merging the one or more user embeddings and the one or more context embeddings to generate one or more merged embeddings; and
generating recommendations based on the one or more merged embeddings.

15. A non-transitory computer-readable medium of claim 14, wherein the recommendation model further comprises:
a first model, which processes the one or more user features and generates the one or more user embeddings;
a second model, which processes the one or more context inputs and generates the one or more context embeddings;
a merge layer, which processes the one or more user embeddings and the one or more context embeddings and generates the one or more merged embeddings; and
a dense layer, which processes the one or more merged embeddings and generates the recommendations.

16. A non-transitory computer-readable medium of claim 15, wherein the first model is a user foundation model.

17. A non-transitory computer-readable medium of claim 14, wherein determining the one or more context features based on the one or more context inputs further comprises in response to determining that the one or more context inputs are not available, imputing the one or more context inputs.

18. A non-transitory computer-readable medium of claim 17, wherein imputing the one or more context inputs comprises applying a plurality of heuristics, the plurality of heuristics comprising at least one of:
assigning a null value to the title context input when a source title is missing;
enriching the missing context by extracting relevant information from a source title; or
extracting context input based on typical user engagement determined from historical user interaction data.

19. A non-transitory computer-readable medium of claim 14, wherein determining the one or more user embeddings based on the one or more user features further comprises:
in response to determining that the one or more user embeddings are not cached generating, using a user foundation model, the one or more user embeddings based on the one or more user features and caching the one or more user embeddings; and
in response to determining that the one or more user embeddings are cached, retrieving one or more user embeddings from the cache.

20. A system, comprising:
one or more memories storing instructions; and
one or more processors that are coupled to the one or more memories and, when executing the instructions, are configured to:
receiving one or more user inputs;
determining one or more context features based on one or more context inputs;
determining one or more user features based on the one or more user inputs;
determining one or more user embeddings based on the one or more user features;
determining one or more context embeddings based on the one or more context features;
merging the one or more user embeddings and the one or more context embeddings to generate one or more merged embeddings; and
generating recommendations based on the one or more merged embeddings.
